(19) United States
(12) Patent Application Publication
(10) Pub. No.: US 2026/0337921 A1
(43) Pub. Date: Oct. 29, 2026

(54) GANTRY CABLE SERVICE SYSTEM

(71) Applicant: Joy Global Surface Mining Inc, Milwaukee, WI (US)

(72) Inventors: Atticus Clark, Elm Grove, WI (US); Richard L. Nicoson, Hartford, WI (US)

(21) Appl. No.: 19/661,340

(22) Filed: Apr. 28, 2026

Related U.S. Application Data
(60) Provisional application No. 63/796,161, filed on Apr. 28, 2025.

(51) Int. Cl. E02F 9/14; B25B 25/00

(52) U.S. Cl. CPC E02F 9/14; B25B 25/00

(57) ABSTRACT

A suspension cable service system for installing and/or removing suspension cables of an industrial machine. The suspension cables may support a boom of the industrial machine and may be coupled to a gantry of the industrial machine. The service system includes a suspension cable clamp configured to be secured to a suspension cable, a suspension cable fixture configured to be mounted on a mounting assembly of the gantry, and a suspension cable pin retainer configured to couple between a retaining pin for the suspension cable and a mounting end of the suspension cable. The suspension cable fixture includes one or more attachment points for coupling a tugger assembly between the suspension cable fixture and the suspension cable clamp.

### CROSS-REFERENCE TO RELATED APPLICATION

This application claims priority to and the benefit of co-pending U.S. Provisional Patent Application No. 63/796,161, filed Apr. 28, 2025, the disclosure of which is hereby incorporated herein by reference in its entirety.

### TECHNICAL FIELD

This disclosure relates generally to mining machines and, more particularly, to mining shovels that include a boom supported by suspension cables and a gantry.

### BACKGROUND

Some mining machines include a dipper supported by and suspended from a boom. The boom may extend upwardly and outwardly from a frame of the machine and is supported by suspension cables and a gantry.

### SUMMARY

The present disclosure provides a suspension cable service system for a mining machine (e.g., a rope shovel). The suspension cable service system can be used to install and/or remove suspension cables to a gantry, and the suspension cables support an outward and upward extending boom. The system includes one or more suspension cable clamps, a suspension cable pin retainer, and a suspension cable fixture. The suspension cable clamp(s) can be mounted to the suspension cable. The clamp(s) may include a body that is secured around the suspension cable. One or more clamps may include a lifting bracket extending from the body that allows a crane or other lifting machine to support and hold the weight of the suspension cable. One or more clamps may include one or more aligning brackets for attaching one or more tugger assemblies or “come-alongs” that can be used to bring an end of the suspension cable into a mounting position with a mounting bracket of the gantry. The suspension cable pin retainer prevents a retaining pin for the suspension cable from detaching from the gantry. In some embodiments, the suspension cable pin retainer may include one or more tugger brackets, with a tugger assembly extending between and operably coupled to the tugger bracket and a suspension cable fixture. The suspension cable fixture is mounted on the gantry and reacts off the gantry without adding any stress concentrations from welding. The suspension cable fixture can allow for consistent rigging points for tugger assemblies or come-alongs for top and bottom bores of the gantry.

In one independent aspect, provided herein is a suspension cable service system for installing and/or removing a suspension cable of an industrial machine including a gantry. The suspension cable service system includes a suspension cable clamp configured to be secured to the suspension cable, a suspension cable fixture configured to be mounted on a mounting assembly of the gantry, and a suspension cable pin retainer configured to couple between a retaining pin for the suspension cable and a mounting end of the suspension cable. The suspension cable fixture includes one or more attachment points for coupling a tugger assembly between the suspension cable fixture and the suspension cable clamp.

In some aspects, the suspension cable clamp includes a lifting member configured to engage a lifting machine and support a weight of the suspension cable.

In some aspects, the suspension cable clamp includes an alignment member configured to couple to the tugger assembly.

In some aspects, the suspension cable clamp includes a tubular body segmented into two body segments. In some aspects, the body segments are hingedly connected to each other. In some aspects, each body segment includes a flange for removably connecting to the flange of the other body segment.

In some aspects, the suspension cable clamp includes a liner positioned in the tubular body.

In some aspects, the suspension cable fixture includes a back portion and a pair of anti-rotation arms extending from the back portion. In some aspects, the back portion is configured to mount to a mounting support of the mounting assembly. In some aspects, the anti-rotation arms are configured to straddle the mounting support.

In some aspects, the suspension cable fixture includes a back plate extending along the back portion. In some aspects, the back plate defines multiple attachment points for the tugger assembly.

In some aspects, the suspension cable pin retainer includes a shroud configured to cover a portion of a tail of the retaining pin and a lip configured to engage a head of the retaining pin.

In some aspects, the suspension cable pin retainer further includes an arm with an adjustable gripping claw configured to engage the mounting end of the suspension cable.

In some aspects, the suspension cable clamp and the suspension cable pin retainer are separate components.

In some aspects, the suspension cable clamp and the suspension cable pin retainer form an integrated unit.

In another independent aspect, provided herein is an industrial machine including a base, a boom extending upwardly and outwardly from the base, a gantry supported by the base, the gantry including a mounting assembly, a suspension cable supporting the boom, a mounting end of the suspension cable coupled to the mounting assembly of the gantry via a retaining pin, and a suspension cable service system. The suspension cable service system includes a suspension cable clamp secured to the suspension cable, and a suspension cable fixture mounted on the mounting assembly of the gantry. The suspension cable fixture includes one or more attachment points for coupling a tugger assembly between the suspension cable fixture and the suspension cable clamp.

In some aspects, the suspension cable service system further includes a suspension cable pin retainer coupled between the retaining pin and the mounting end of the suspension cable.

In some aspects, the suspension cable pin retainer includes a shroud configured to cover a portion of a tail of the retaining pin and a lip configured to engage a head of the retaining pin. In some aspects, the suspension cable pin retainer further includes an arm with an adjustable gripping claw configured to engage the mounting end of the suspension cable.

In some aspects, the industrial machine is a rope shovel further including a digging attachment supported by a hoist rope extending over an end of the boom.

In some aspects, the mounting assembly includes a mounting support, a mounting linkage, and a mounting bracket. In some aspects, the suspension cable fixture is mounted on the mounting support and the mounting end of the suspension cable is coupled to the mounting bracket via the retaining pin.

In some aspects, the suspension cable fixture includes a back portion and a pair of arms extending from the back portion. In some aspects, the back portion is configured to mount to the mounting support. In some aspects, the arms are configured to straddle the mounting support and engage between the mounting linkage and a support leg of the gantry.

In another independent aspect, provided herein is a method of servicing a suspension cable of an industrial machine. The method includes: securing at least one suspension cable clamp on the suspension cable; mounting a suspension cable fixture on a mounting assembly of a gantry of the industrial machine; positioning a mounting end of the suspension cable proximate the mounting assembly using a lifting machine that engages the at least one suspension cable clamp, where the at least one suspension cable clamp supports a weight of the suspension cable; aligning the mounting end of the suspension cable with a bore of the mounting assembly via a tugger assembly coupled between the at least one suspension cable clamp and the suspension cable fixture; and inserting a retaining pin through the mounting end of the suspension cable and the bore of the mounting assembly.

In some aspects, the method further includes installing a suspension cable pin retainer on the retaining pin and the mounting end of the suspension cable, wherein the suspension cable pin retainer limits the retaining pin from backing out of the bore.

In some aspects, the method further includes: removing the retaining pin from the mounting end and the bore of the mounting assembly; uncoupling the tugger assembly from the at least one suspension cable clamp; and repositioning the mounting end of the suspension cable away from the mounting assembly using the lifting machine.

Features of the above-described aspects may be combined in any suitable combination.

The following description and the appended figures set forth certain features for purposes of illustration. Advantages will become more apparent when reading the present disclosure in its entirety.

### BRIEF DESCRIPTION OF DRAWINGS

So that the above-recited features may be understood in detail, a more particular description, briefly summarized above, may be had by reference to example aspects, some of which are illustrated in the appended drawings.

FIG. 1 is a side view of a mining machine.

FIG. 2 is a perspective view of a gantry of a mining machine.

FIG. 3 is a magnified view of a suspension cable service system for installing a suspension cable on the gantry of FIG. 2.

FIGS. 4A and 4B are isolated perspective views of a suspension cable clamp of the suspension cable service system of FIG. 3.

FIGS. 5A and 5B are isolated perspective views of a suspension cable fixture of the suspension cable service system of FIG. 3.

FIG. 6 is an isolated view of a suspension cable pin retainer of the suspension cable service system of FIG. 3.

FIG. 7 is a magnified view of another suspension cable service system for installing a suspension cable on the gantry of FIG. 2.

FIG. 8 is an isolated perspective view of a suspension cable fixture of the suspension cable service system of FIG. 7.

FIG. 9 is an isolated perspective view of an integrated alignment member and pin retainer of the suspension cable service system of FIG. 7.

FIG. 10 is a magnified view of another suspension cable service system for installing a suspension cable on the gantry of FIG. 2.

FIG. 11 is a process flow diagram of a method of installing a suspension cable of an industrial machine.

Corresponding reference numbers in the drawings indicate corresponding parts.

### DETAILED DESCRIPTION

The embodiments described herein are not limited to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. When introducing elements of various embodiments of the present disclosure, the articles “a,” “an,” and “the” are intended to mean that there are one or more of the elements. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. References to “one embodiment” or “an embodiment” of the present disclosure are not intended to be interpreted as excluding the existence of additional embodiments that also incorporate the recited features.

Relative terminology, such as, for example, “about,” “approximately,” “substantially,” and the like, used in connection with a quantity or condition would be understood by those of ordinary skill to be inclusive of the stated value and has the meaning dictated by the context (for example, the term includes at least the degree of error associated with the measurement accuracy, tolerances (for example, manufacturing, assembly, use, and the like) associated with the particular value, and the like).

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

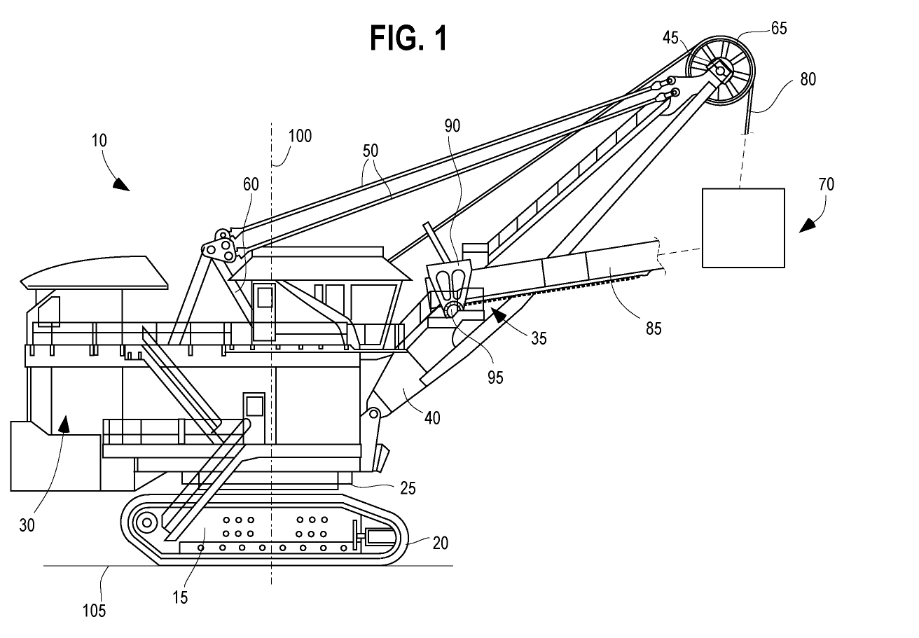

FIG. 1 illustrates an industrial machine (e.g., a mining machine such as a rope shovel or a power shovel 10). In the illustrated embodiment, the shovel 10 includes a mobile base 15, traction elements (e.g., drive tracks 20), a rotational structure (e.g., turntable) 25, a revolving frame 30, a boom 35 having a lower end 40 (also called a boom foot) and an upper end 45 (also called a boom point). One or more tension members (e.g., suspension cables 50) may extend between the upper end 45 and a gantry 60, and one or more sheaves 65 may be mounted on the upper end 45 of the boom 35.

The shovel 10 also includes a digging attachment 70 (e.g., a dipper, illustrated schematically). In some embodiments, the shovel 10 may be configured similar to the rope shovel described in U.S. Publication No. 2026/0002333, published Jan. 1, 2026, which is hereby incorporated herein by reference in its entirety. The digging attachment 70 may be configured similar to the dipper described in U.S. Publication No. 2026/0002333; however, the digging attachment 70 of the shovel 10 of FIG. 1 can have any suitable structure which may be different from the dipper of U.S. Publication No. 2026/0002333.

One or more hoist ropes 80 extend over the sheaves 65 and are coupled to a hoist drum (not shown), and an end of the hoist ropes 80 may be coupled to the digging attachment 70. In the illustrated embodiment, the mining machine may include a handle 85 for supporting the digging attachment 70, and a saddle block 90, a shipper shaft 95, and a transmission unit (also called a crowd drive, not shown) may support the handle 85 for movement relative to the boom 35. In other embodiments, the digging attachment may be supported in a different manner (e.g., the digging attachment may be coupled to a stick including a telescoping cylinder and a pivotable yoke – not shown).

The rotational structure 25 may allow rotation of the revolving frame 30 relative to the mobile base 15. In some embodiments, the rotational structure defines a rotational axis 100 of the shovel 10. The rotational axis 100 may be perpendicular to a plane 105 defined by the base 15, generally corresponding to a grade of the ground or support surface. The mobile base 15 is supported by the drive tracks 20. The mobile base 15 supports the rotational structure 25 and the revolving frame 30. The rotational structure 25 may be capable of 360 degrees of rotation relative to the mobile base 15.

The hoist rope(s) 80 is anchored to the winch drum (not shown) of the revolving frame 30, and is wrapped over the sheave(s) 65 and coupled to the dipper 70. The winch drum is driven by at least one electric motor (not shown) that incorporates a transmission unit (not shown). As the winch drum rotates, the hoist rope(s) 80 is paid out to lower the dipper 70 or pulled in to raise the dipper 70. The dipper handle 85 is also coupled to the dipper 70. In the illustrated embodiment, the dipper handle 85 is slidably supported in the saddle block 90, and the saddle block 90 is pivotally mounted to the boom 35 at the shipper shaft 95. The dipper handle 85 includes a rack and tooth formation thereon that engages a drive pinion (not shown) mounted in the saddle block 90. The drive pinion is driven by an electric motor and transmission unit (not shown) to extend or retract the dipper handle 85 relative to the saddle block 90.

An electrical power source (not shown) is mounted to the revolving frame 30 to provide power to a hoist electric motor (not shown) for driving the winch drum, one or more crowd electric motors (not shown) for driving the crowd transmission unit, and one or more swing electric motors (not shown) for turning the rotational structure 25. Each of the crowd, hoist, and swing motors is driven by its own motor controller, or is alternatively driven in response to control signals from a controller (not shown).

The boom 35 is pivotally connected at the lower end 40 to the revolving frame 30. The boom 35 is held in an upwardly and outwardly extending relation to the revolving frame 30 by the suspension cables 50, which are anchored to the gantry 60. The gantry 60 may be mounted on the revolving frame 30.

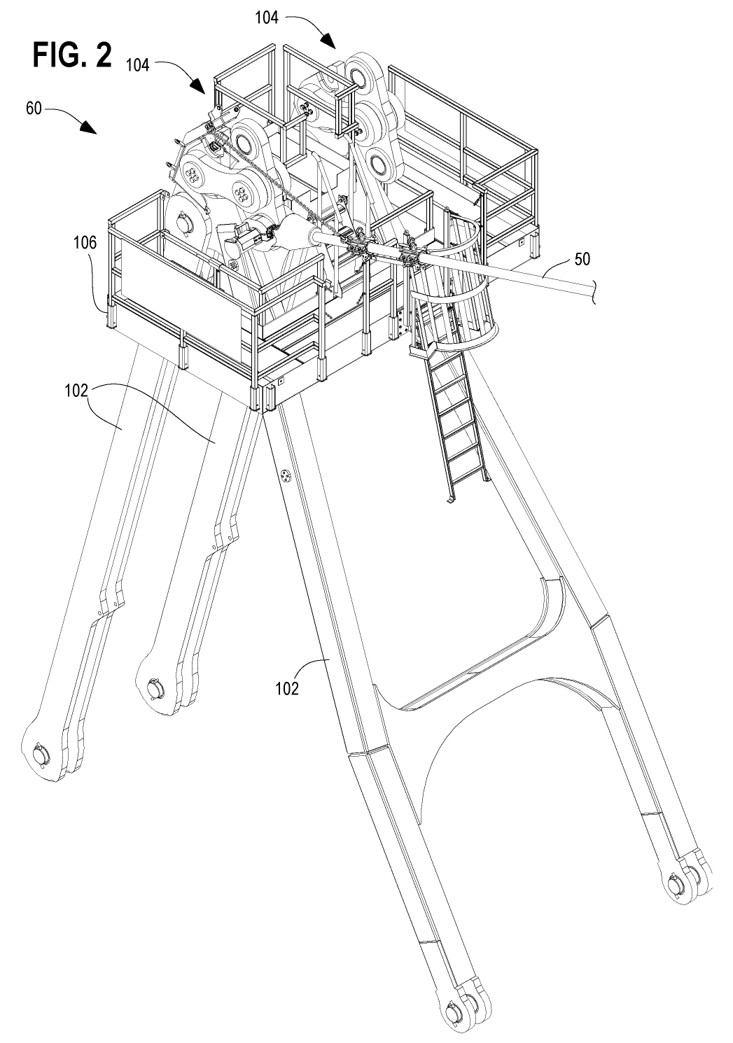

Referring to FIG. 2, the gantry 60 may include support legs 102 that converge at mounting assemblies 104 for supporting the suspension cables 50. A single suspension cable 50 is shown in FIG. 2; however, multiple suspension cables, such as two, three, four, or more than four, suspension cables may be coupled to the mounting assemblies 104 for supporting the boom 35 (FIG. 1). As an example, each mounting assembly 104 may be configured to couple to two suspension cables 50. Each support leg 102 may be mounted to the revolving frame 30 (FIG. 1). An operator platform 106 may surround the mounting assemblies 104; the operator platform 106 may provide a support surface for operators when installing the suspension cables 50 to the gantry 60 and/or removing the suspension cables 50 from the gantry 60.

Various challenges are encountered during servicing of the suspension cables 50, which may include installation/assembly as well as removal/disassembly of the suspension cables 50 between the gantry 60 and the boom 35. Some examples of the challenges include: lifting the cables from the ground to a staging position; lifting the cables to the gantry for installation; tugging and aligning cable sockets of the cables with bores during final positioning; holding and installing retaining pins for the cables; installing new retaining pins and cable sockets; and/or removing, repairing, and replacing worn retaining pins and cables. Typically, conventional basic rigging and crane lift principles are applied. Synthetic slings can be used to lift the cables. Occasionally, chains and cable clamps are employed. Standard chain tuggers may be attached to the gantry and to the cables via slings or clamps. Safe work practices and field-level risk assessment are important considerations for suspension cable installation and removal and can differ by site.

The suspension cable service system described herein provides improvements in safety and/or efficiency of installing and removing the suspension cables in a cost-effective manner. For example, the suspension cable service system hereof can enable/provide one or more of the following: eliminating the need to wrap lifting chains or slings around strands of the cables that can slip and cause damage to the rope or cable; dedicated rigging location on a pendant of the cable; dedicated lugs or attachment points for a tugger relative to the gantry; supporting the retaining pin and preventing the retaining pin from backing out or coming loose from its attachment point.

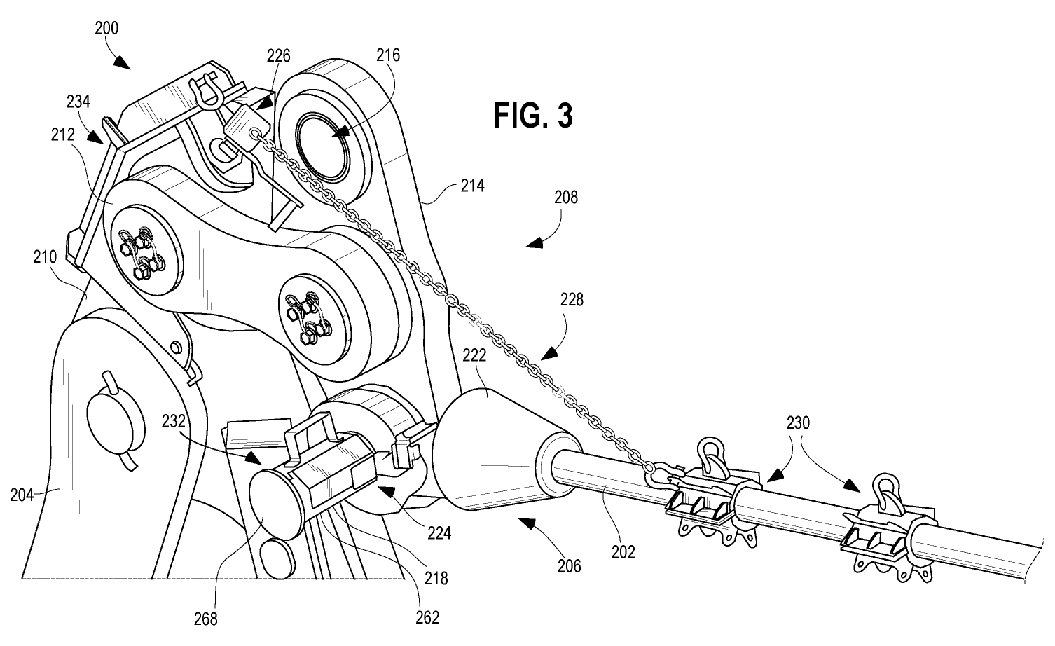

Referring to FIG. 3, a suspension cable service system 200 for a mining machine (e.g., a rope shovel, such as the shovel 10 of FIG. 1) is shown. The suspension cable service system 200 can be used to install one or more suspension cables 202 to a gantry 204 and/or remove the suspension cable(s) 202 from the gantry 204. The gantry 204 may be similar to, for example, the gantry 60 of FIGS. 1 and 2. The suspension cable(s) 202 may be used to support an outward and upward extending boom, e.g., the boom 35 of FIG. 1. A single suspension cable 202 is shown in FIG. 3; however, the service system 200 may be used to install and/or remove multiple suspension cables 202. Description of the suspension cable 202 and features of the service system 200 that facilitate installation and/or removal of the suspension cable 202 are similarly applicable in examples where multiple suspension cables 202 are provided.

The suspension cable 202 includes a mounting end 206 that can be coupled to a mounting assembly 208 of the gantry 204 via the system 200. The mounting assembly 208 may include a mounting support 210 coupled between support legs of the gantry 204 (e.g., support legs 102 of FIG. 2), a mounting linkage 212, and a mounting bracket 214. The mounting bracket 214 may define one or more mounting bores 216 configured to receive one or more retaining pins 218 for coupling one or more suspension cables 202 to the gantry 204. The mounting linkage 212 may be configured to pivot relative to the mounting support 210 and the mounting bracket 214 may be configured to pivot relative to the mounting linkage 212. Pivoting movement of the mounting linkage 212 and the mounting bracket 214 may allow for re-positioning of the mounting end 206 of the suspension cable(s) 202 relative to the mounting support 210.

The mounting end 206 of the suspension cable 202 may include a coupler 222 having an alignment bore 224 configured to align with one of the mounting bores 216 of the mounting bracket 214. The retaining pin 218 can be inserted in the aligning pair of bores 216, 224 of the mounting bracket 214 and the coupler 222 to secure the suspension cable 202 to the gantry 204. A tugger assembly 226 (e.g., a lever chain hoist, a tensioner, a tugger, etc.) can be used to apply tension between the gantry 204 and the suspension cable 202, e.g., via a tugger chain 228 coupled between the mounting assembly 208 and the suspension cable 202.

The system 200 provides one or more cable clamps 230, a suspension cable pin retainer 232 (or pin holder), and a suspension cable fixture 234 (or a tugger attachment feature). One or more cable clamps 230 may be provided for each cable 202, and a suspension cable pin retainer 232 may be provided for each retaining pin 218. Thus, in embodiments where multiple suspension cables 202 are coupled via their respective couplers 222 to the mounting bracket 214 via multiple pins 218, multiple sets of one or more cable clamps 230 and multiple pin retainers 232 may be included in the system 200. In some embodiments, the system 200 may include a single cable fixture 234, which can be used for one suspension cable 202 or multiple suspension cables coupled to the gantry 204. Additionally, the system 200 may be configured for use with one mounting assembly 208 of the gantry 204. In some embodiments, e.g., as shown in FIG. 2, the gantry 204 may include multiple mounting assemblies, and multiple systems 200 can be used for the multiple mounting assemblies.

The system 200 may operate in conjunction with common lifting machines (e.g., cranes) and practices for lifting the suspension cable 202 via the clamp(s) 230, which may be secured on the suspension cable 202. The tugger assembly 226 and the tugger chain 228 may be operably coupled between the suspension cable fixture 234, which may be mounted on the mounting support 210 of the gantry 204, and one of the clamps 230 positioned on the suspension cable 202 at or proximate the mounting end 206. Commonly used tugger assemblies (e.g., lever chain hoists) can be employed. The suspension cable fixture 234 and the clamp 230 may cooperate to provide a dedicated location for coupling the tugger assembly 226 and the tugger chain 228 between the gantry 204 and the suspension cable 202. The suspension cable pin retainer 232 may be configured to maintain the retaining pin 218 in the aligned pair of bores 216, 224. The suspension cable pin retainer 232 may reduce the risk of falling object(s) (e.g., the suspension cable 202) and lifting hazards.

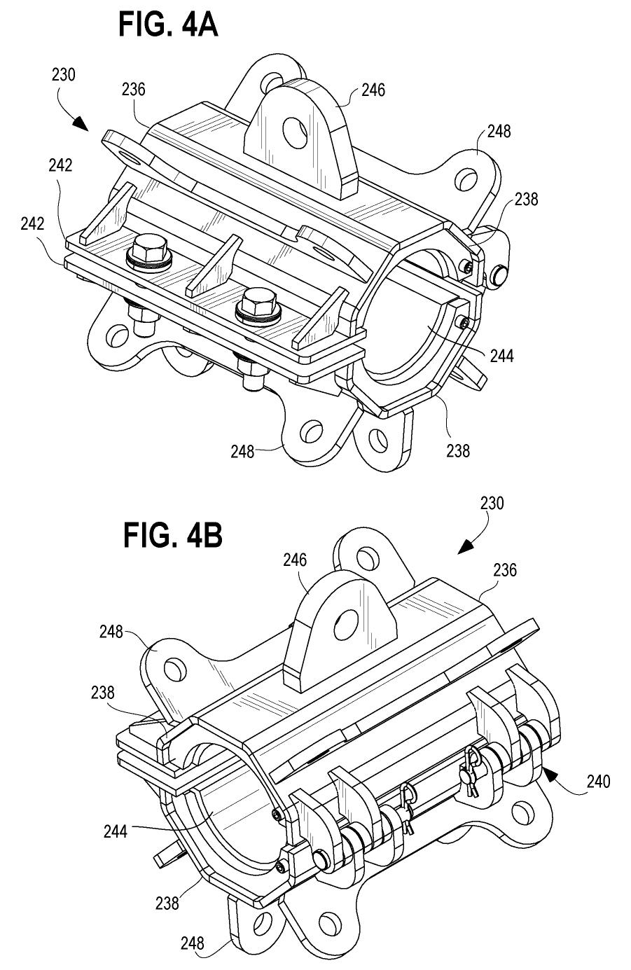

With additional reference to FIGS. 4A and 4B, each suspension cable clamp 230 may include a tubular body 236 that can be secured around the suspension cable 202. The tubular body 236 may be segmented into two body segments 238 that are hingedly connected to one another via a hinge 240. Each body segment 238 may include a flange 242, and the flanges 242 can be coupled or fastened, e.g., via bolts, or other suitable attachment means, to secure the clamp 230 on the suspension cable 202. The segmented and hinged construction of the body 236 may facilitate efficient and simplistic installation of the clamp 230 onto the suspension cable 202. The tubular body 236 may also include a liner 244, which may be cooperatively formed by liner segments of the body segments 238. The liner 244 may be constructed of nylon or another suitable material and may ensure sufficient engagement between the clamp 230 and the suspension cable 202.

The body 236 may include a lifting member, e.g., a lifting lug 246, extending from the body. The lifting lug 246 may be configured with suitable rigidity and structural strength to allow a crane or other lifting machine to support and hold the weight of the suspension cable 202 via the lifting lug 246 of the clamp 230 secured to the suspension cable 202. The body 236 may also include one or more alignment members, e.g., one or more aligning brackets 248, for attaching the tugger chain 228 (FIG. 3) and/or come-alongs that operate to move the mounting end 206 of the suspension cable 202 toward the mounting assembly 208 to align the bores 216, 224 that receive the retaining pin 218. Multiple aligning brackets 248 may be positioned in a circumferential arrangement about the body 236 to allow for rotational adjustment of the clamp 230 about the suspension cable 202. Moreover, the multiple aligning brackets 248 may provide various different locations about the body 236 for attaching the tugger chain 228 and/or come-alongs to facilitate efficient and simplistic installation and assembly. In some embodiments, the clamp 230 can be used for installing the suspension cable 202. In some embodiments, the clamp 230 can be used for removing the suspension cable 202. In some embodiments, the clamp 230 may increase friction, e.g., via the liner 244, to prevent slippage between the suspension cable 202 and the lifting components and may protect outer strands of the cable from damage.

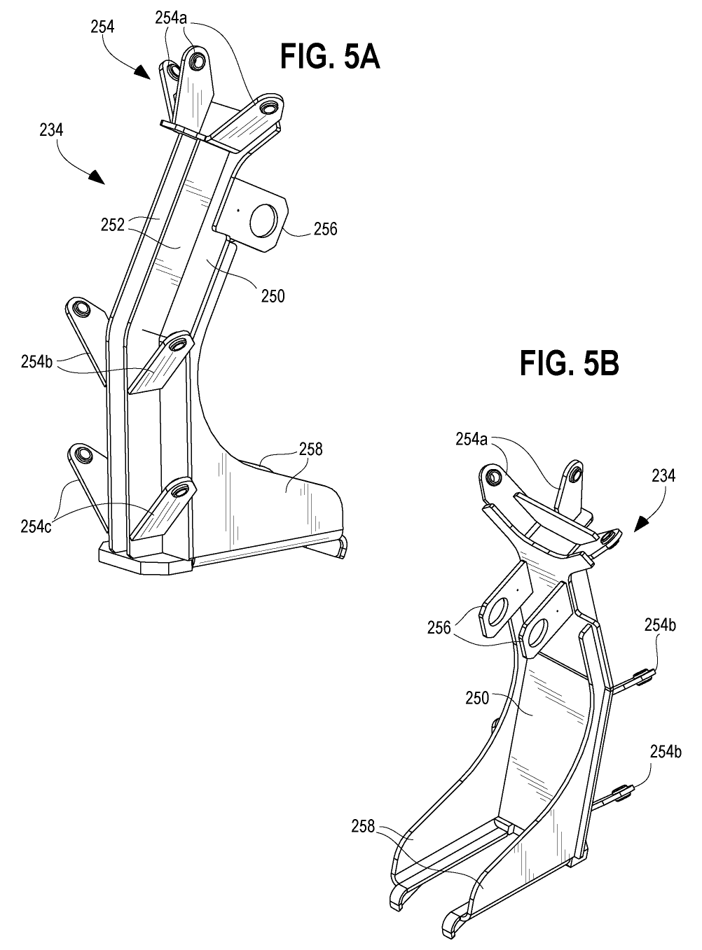

Referring again to FIG. 3 and with additional reference to FIGS. 5A and 5B, the suspension cable fixture 234 may have a “horse head” shape or another suitable shape that is configured for mounting on the mounting support 210 of the gantry 204. The suspension cable fixture 234 may include a back portion 250 that is configured (e.g., sized and shaped) to interface or mate with an edge of the mounting support 210. A pair of back plates 252 may extend along and outwardly from an outer surface of the back portion 250 and support a plurality of shackle members 254. The shackle members 254 may define attachment points for coupling a tugger assembly 226 and a tugger chain 228, and/or come-alongs, to the suspension cable fixture 234. The plurality of shackle members 254 may include a first or upper set of shackle members 254a, a second or middle set of shackle members 254b, and a third or lower set of shackle members 254c. The sets of shackle members 254 may provide attachment points at different locations along the back portion 250 for coupling tugger assemblies and tugger chains, and/or come-alongs, at the different locations. Moreover, the multiple sets of shackle members 254 may allow for coupling multiple tugger assemblies and tugger chains to the suspension cable fixture 234, which in turn can be attached to multiple clamps 230 on multiple suspension cables 202. In this way, a single suspension cable fixture 234 may support multiple suspension cables 202 coupled to the same mounting assembly 208.

A pair of anchors 256 may extend outwardly from the back portion 250, opposite the back plates 252. The anchors 256 may straddle the mounting support 210 and may facilitate securing the suspension cable fixture 234 to the mounting support 210. For example, the anchors 256 may be attached to the mounting support 210 via fasteners, pins, or another suitable attachment means.

The suspension cable fixture 234 may also include a pair of anti-rotation arms 258 extending outwardly from the back portion 250 in generally the same direction as the anchors 256. The anti-rotation arms 258, like the anchors 256, may straddle the mounting support 210. As shown in FIG. 3, the anti-rotation arms 258 may be positioned between a support leg of the gantry 204 and the linkage 212 and may facilitate limiting or preventing rotation of the suspension cable fixture 234 relative to the mounting support 210. While the arms 258 may engage between a support leg and the linkage 212 in the illustrated embodiment, the arms 258 may engage any suitable one or more support elements of the mounting support 210 and/or mounting assembly 208 to facilitate the anti-rotation functionality.

The suspension cable fixture 234 may be mounted on the gantry 204 and may react off the gantry 204 without substantially adding stress concentrations from welding. The suspension cable fixture 234 can allow for consistent rigging points for the tugger assembly 226 and/or come-alongs for the top and bottom bores 216 of the mounting assembly 208 of the gantry 204.

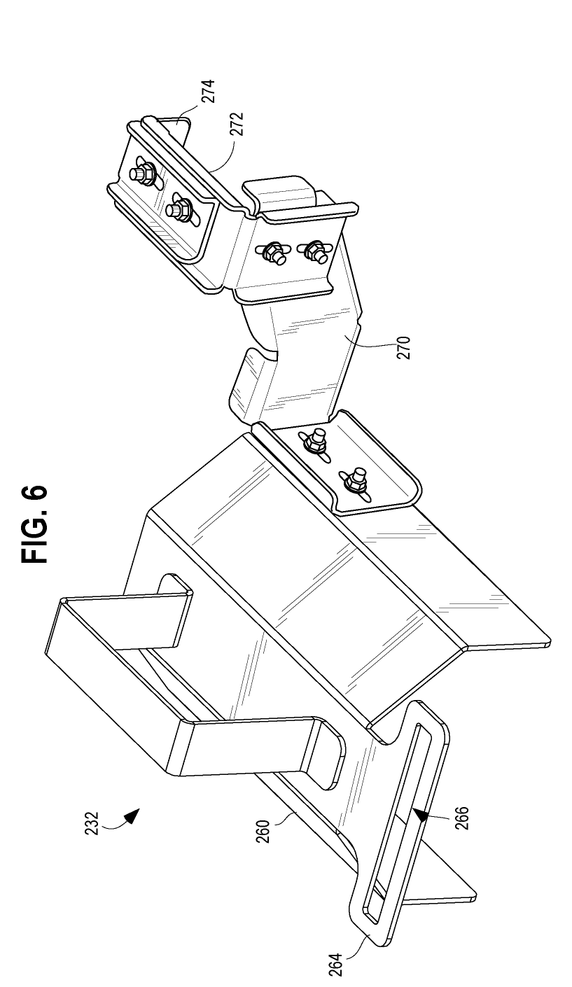

Referring again to FIG. 3 and with additional reference to FIG. 6, the suspension cable pin retainer 232 may operate to prevent the retaining pin 218 for the suspension cable 202 from prematurely coming loose from (or “backing out of”) the aligned pair of bores 216, 224. In this example, the pin retainer 232 may include a pin cover or shroud 260 configured to mount to a tail 262 of the retaining pin 218. In particular, the shroud 260 may be mounted on a portion of the tail 262 that extends outwardly beyond the aligned pair of bores 216, 224 when the retaining pin 218 is inserted therein. The pin retainer 232 may also include a lip 264 extending outwardly from the shroud 260 and defining a slot 266 that receives a circumferential edge of a head 268 of the retaining pin 218. The lip 264 may receive the edge of the head 268 to retain the shroud 260 on the tail 262 and limit or prevent outward movement of the retainer 232 relative to the retaining pin 218.

The pin retainer 232 may also include an arm 270 coupled to and extending from the shroud 260. The arm 270 may be coupled to the shroud 260 using nuts, bolts, pins, or other suitable attachment means. The arm 270 includes an adjustable gripping claw 272 that is configured to engage the suspension cable 202. For example, as shown in FIG. 3, the gripping claw 272 may engage the coupler 222 of the suspension cable 202. The gripping claw 272 includes a terminal finger 274 that serves as a stop against the suspension cable 202. The lip 264 and the gripping claw 272 may cooperate to provide a clamp between the retaining pin 218 and the suspension cable 202, thereby limiting or preventing the retaining pin 218 from prematurely coming loose from (or “backing out of”) the aligned pair of bores 216, 224. The gripping claw 272 may be adjustable to move the finger 274 relative to the arm 270, which can accommodate different distances between the head 268 of the retaining pin 218 and the coupler 222 while maintaining a sufficient clamp therebetween.

The cable clamps 230, the suspension cable pin retainer 232, and the suspension cable fixture 234 can be used, in any combination, to install the suspension cable 202 to the gantry 204 and/or remove the suspension cable 202 from the gantry 204.

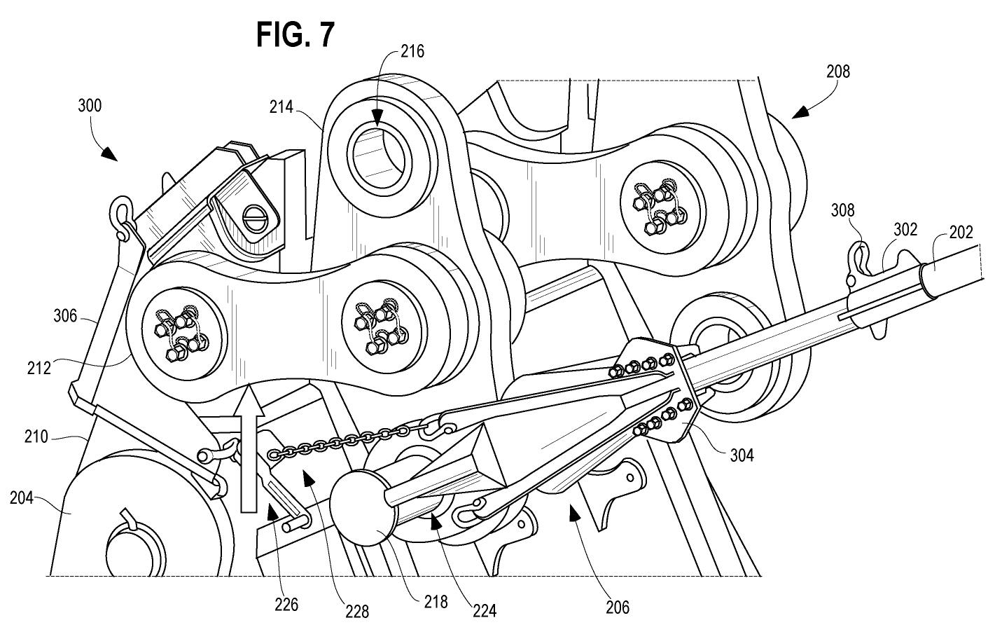

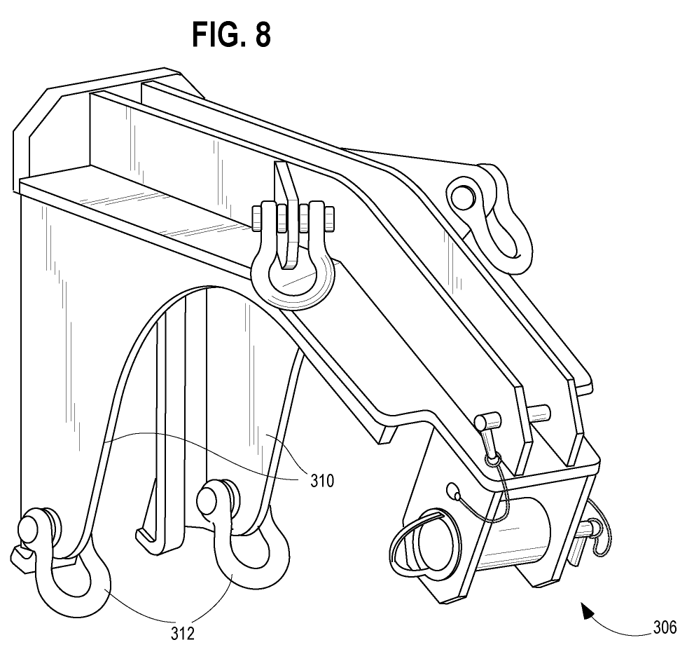

Referring to FIG. 7, another example of a suspension cable service system 300 for a mining machine (e.g., a rope shovel, such as the shovel 10 of FIG. 1) is shown. The suspension cable service system 300, similar to the suspension cable service system 200, can be used to install one or more suspension cables 202 to the gantry 204 and/or remove the suspension cable(s) 202 from the gantry 204. In this example, the system 300 includes a lifting clamp 302 supported on the suspension cable 202, an integrated alignment member and pin retainer 304, and a suspension cable fixture 306 mounted on the mounting support 210. The lifting clamp 302 may include a lifting feature 308, e.g., a shackle, that is configured to allow a crane or other lifting machine to support and hold the weight of the suspension cable 202 via the lifting clamp 302. As shown in FIG. 8, the suspension cable fixture 306 may be shaped similarly to the suspension cable fixture 234 of FIGS. 5A and 5B. In this embodiment, the anti-rotation arms 310 of the suspension cable fixture 306 may include shackle members 312 that define attachment points for coupling a tugger assembly 226 and a tugger chain 228, and/or come-alongs, to the suspension cable fixture 306.

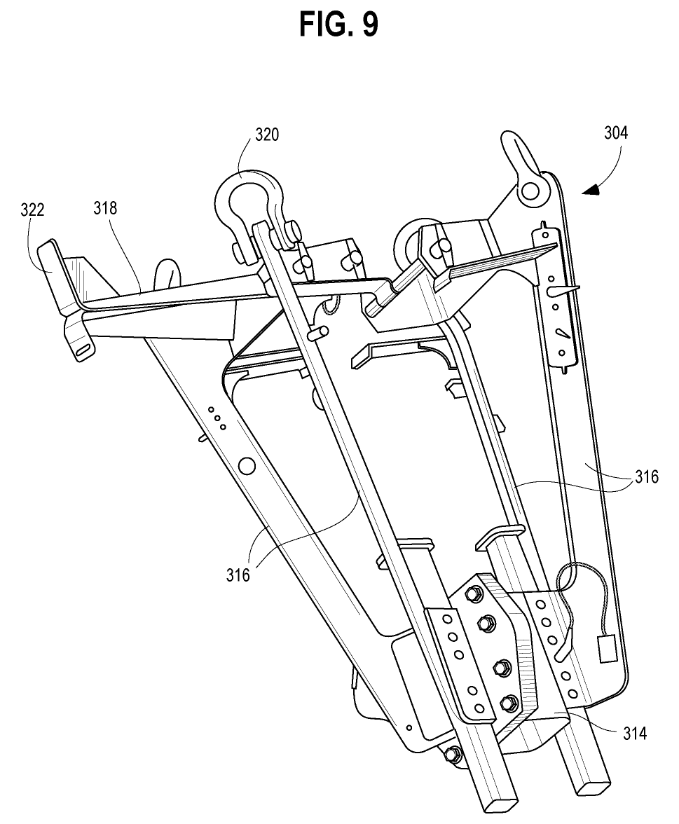

Referring again to FIG. 7 and with additional reference to FIG. 9, the integrated alignment member and pin retainer 304 of this embodiment may include a tubular support 314 secured to the suspension cable 202 and spokes 316 extending rearwardly from the support 314 toward the mounting end 206 and the mounting assembly 208. The spokes 316 may extend to a retaining plate 318 opposite the tubular support 314. The retaining plate 318 may be secured at or proximate the mounting end 206 of the suspension cable 202. One or more tugger brackets 320, e.g., shackles, may be provided at or proximate the retaining plate 318. The tugger bracket(s) 320 may be located at an end of a respective spoke 316. The tugger brackets 320 may define attachment points for coupling to the tugger assembly 226 and the tugger chain 228 (e.g., to a lever chain of the tugger assembly 226). The retaining plate 318 may also include pin stops 322 that extend over the retaining pin 218 to prevent the retaining pin 218 from prematurely coming loose from (or “backing out of”) the aligned pair of bores 216, 224.

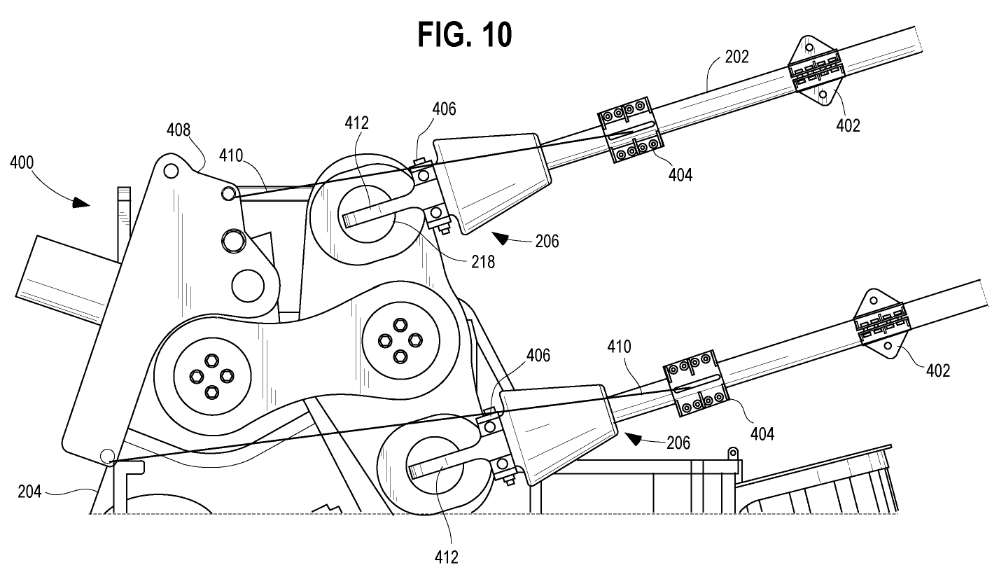

Referring to FIG. 10, another example of a suspension cable service system 400 for a mining machine (e.g., a rope shovel, such as the shovel 10 of FIG. 1) is shown. The suspension cable service system 400, similar to the suspension cable service systems 200 and 300, can be used to install one or more suspension cables 202 to the gantry 204 and/or remove the suspension cable(s) 202 from the gantry 204. Two suspension cables 202 are shown coupled to the mounting bracket 214 via the system 400 in FIG. 10. In this example, the system 400 includes a lifting clamp 402 supported on each suspension cable 202, an alignment clamp 404 supported on each suspension cable 202 proximate the mounting end 206, a pin retainer 406 coupled between each pair of a retaining pin 218 and the mounting end 206 of a cable 202, and a single suspension cable fixture 408 mounted on the gantry 204. Each lifting clamp 402 may be configured to allow a crane or other lifting machine to support and hold the weight of the suspension cable 202 via the lifting clamp 402. Each alignment clamp 404 may be coupled to the suspension cable fixture 408 via a tugger assembly 410; as shown in FIG. 10, the single suspension cable fixture 408 couples to both suspension cables 202 via the alignment clamps 404 and tugger assemblies 410. Each pin retainer 406 may include a retaining arm 412 that extends over the respective retaining pin 218 to prevent the retaining pin 218 for the suspension cable 202 from prematurely coming loose.

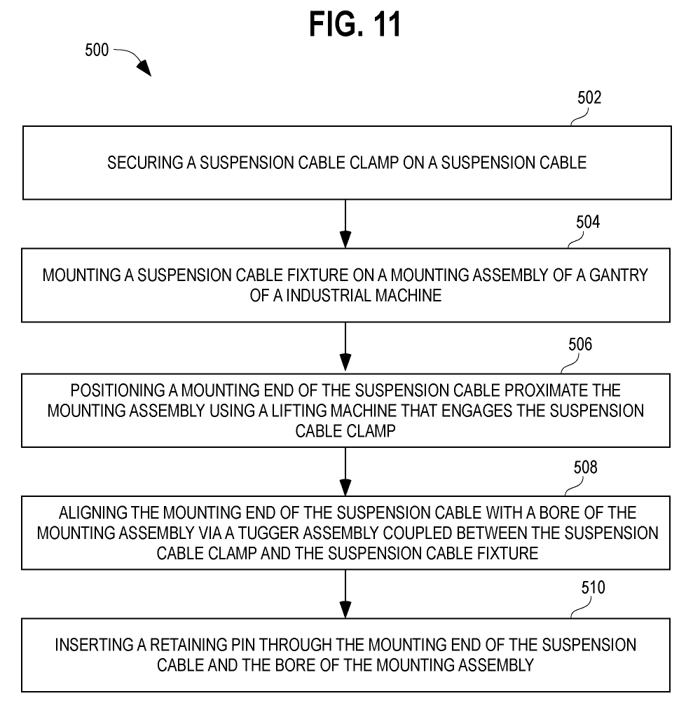

Referring now to FIG. 11, a method 500 of servicing (e.g., installing and/or removing) a suspension cable, e.g., the suspension cable 202, of an industrial machine (e.g., the shovel 10 of FIG. 1) is shown. The method 500 may be performed utilizing any of the suspension cable service systems 200, 300, 400 described above. The method 500 may include securing 502 at least one suspension cable clamp on the suspension cable. The method 500 may also include mounting 504 a suspension cable fixture on a mounting assembly of a gantry of the industrial machine. The method 500 may also include positioning 506 a mounting end of the suspension cable proximate the mounting assembly using a lifting machine that engages the at least one suspension cable clamp, where the at least one suspension cable clamp supports a weight of the suspension cable. The method 500 may also include aligning 508 the mounting end of the suspension cable with a bore of the mounting assembly via a tugger assembly coupled between the at least one suspension cable clamp and the suspension cable fixture. The method 500 may also include inserting 510 a retaining pin through the mounting end of the suspension cable and the bore of the mounting assembly. In some embodiments, the method 500 may include installing a suspension cable pin retainer on the retaining pin and the mounting end of the suspension cable, where the suspension cable pin retainer limits the retaining pin from backing out of the bore. In some embodiments, the method 500 may include disassembling or removing the suspension cable from the mounting assembly by removing the retaining pin from the mounting end and the bore of the mounting assembly, uncoupling the tugger assembly from the at least one suspension cable clamp, and repositioning the mounting end of the suspension cable away from the mounting assembly using the lifting machine. More, fewer, or additional steps of the method 500 may be performed, which can include any of the functionality or operations described above with respect to the suspension cable service systems 200, 300, 400.

The configurations of the embodiments described above can be incorporated in any combination. In other embodiments, other configurations are possible. For example, those of skill in the art will recognize, according to the principles and concepts disclosed herein, that various combinations, sub-combinations, and substitutions of the components discussed above can provide a system incorporating aspects and principles of the present disclosure.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

1. A suspension cable service system for installing and/or removing a suspension cable of an industrial machine including a gantry, the suspension cable service system comprising:
a suspension cable clamp configured to be secured to the suspension cable;
a suspension cable fixture configured to be mounted on a mounting assembly of the gantry, wherein the suspension cable fixture includes one or more attachment points for coupling a tugger assembly between the suspension cable fixture and the suspension cable clamp; and
a suspension cable pin retainer configured to couple between a retaining pin for the suspension cable and a mounting end of the suspension cable.

2. The suspension cable service system of claim 1, wherein the suspension cable clamp includes a lifting member configured to engage a lifting machine and support a weight of the suspension cable.

3. The suspension cable service system of claim 2, wherein the suspension cable clamp further includes an alignment member configured to couple to the tugger assembly.

4. The suspension cable service system of claim 1, wherein the suspension cable clamp includes a tubular body segmented into two body segments, wherein the body segments are hingedly connected to each other, wherein each body segment includes a flange for removably connecting to the flange of the other body segment.

5. The suspension cable service system of claim 4, wherein the suspension cable clamp includes a liner positioned in the tubular body.

6. The suspension cable service system of claim 1, wherein the suspension cable fixture includes a back portion and a pair of anti-rotation arms extending from the back portion, the back portion configured to mount to a mounting support of the mounting assembly, the anti-rotation arms configured to straddle the mounting support.

7. The suspension cable service system of claim 6, wherein the suspension cable fixture includes a back plate extending along the back portion, wherein the back plate defines multiple attachment points for the tugger assembly.

8. The suspension cable service system of claim 1, wherein the suspension cable pin retainer includes a shroud configured to cover a portion of a tail of the retaining pin and a lip configured to engage a head of the retaining pin.

9. The suspension cable service system of claim 8, wherein the suspension cable pin retainer further includes an arm with an adjustable gripping claw configured to engage the mounting end of the suspension cable.

10. The suspension cable service system of claim 1, wherein the suspension cable clamp and the suspension cable pin retainer are separate components.

11. The suspension cable service system of claim 1, wherein the suspension cable clamp and the suspension cable pin retainer form an integrated unit.

12. An industrial machine comprising:
a base;
a boom extending upwardly and outwardly from the base;
a gantry supported by the base, the gantry including a mounting assembly;
a suspension cable supporting the boom, a mounting end of the suspension cable coupled to the mounting assembly of the gantry via a retaining pin; and
a suspension cable service system comprising:
a suspension cable clamp secured to the suspension cable; and
a suspension cable fixture mounted on the mounting assembly of the gantry, wherein the suspension cable fixture includes one or more attachment points for coupling a tugger assembly between the suspension cable fixture and the suspension cable clamp.

13. The industrial machine of claim 12, wherein the suspension cable service system further includes a suspension cable pin retainer coupled between the retaining pin and the mounting end of the suspension cable.

14. The industrial machine of claim 13, wherein the suspension cable pin retainer includes a shroud configured to cover a portion of a tail of the retaining pin and a lip configured to engage a head of the retaining pin, wherein the suspension cable pin retainer further includes an arm with an adjustable gripping claw configured to engage the mounting end of the suspension cable.

15. The industrial machine of claim 12, wherein the industrial machine is a rope shovel further including a digging attachment supported by a hoist rope extending over an end of the boom.

16. The industrial machine of claim 12, wherein the mounting assembly includes a mounting support, a mounting linkage, and a mounting bracket, wherein the suspension cable fixture is mounted on the mounting support and the mounting end of the suspension cable is coupled to the mounting bracket via the retaining pin.

17. The industrial machine of claim 16, wherein the suspension cable fixture includes a back portion and a pair of arms extending from the back portion, the back portion configured to mount to the mounting support, the arms configured to straddle the mounting support and engage between the mounting linkage and a support leg of the gantry.

18. A method of servicing a suspension cable of an industrial machine, the method comprising:
securing at least one suspension cable clamp on the suspension cable;
mounting a suspension cable fixture on a mounting assembly of a gantry of the industrial machine;
positioning a mounting end of the suspension cable proximate the mounting assembly using a lifting machine that engages the at least one suspension cable clamp, wherein the at least one suspension cable clamp supports a weight of the suspension cable;
aligning the mounting end of the suspension cable with a bore of the mounting assembly via a tugger assembly coupled between the at least one suspension cable clamp and the suspension cable fixture; and
inserting a retaining pin through the mounting end of the suspension cable and the bore of the mounting assembly.

19. The method of claim 18, further comprising installing a suspension cable pin retainer on the retaining pin and the mounting end of the suspension cable, wherein the suspension cable pin retainer limits the retaining pin from backing out of the bore.

20. The method of claim 18, further comprising:
removing the retaining pin from the mounting end and the bore of the mounting assembly;
uncoupling the tugger assembly from the at least one suspension cable clamp; and
repositioning the mounting end of the suspension cable away from the mounting assembly using the lifting machine.
